(19) United States
(12) Patent Application Publication
(10) Pub. No.: US 2005/0096116 A1
(43) Pub. Date: May 5, 2005

(54) Reverse lottery system and method

(76) Inventor: Barry M. Mindes, Wayne, NJ (US)

Correspondence Address: JONES DAY, 222 EAST 41ST ST, NEW YORK, NY, 10017, US

(21) Appl. No.: 10/978,122

(22) Filed: Oct. 28, 2004

Related U.S. Application Data
(60) Provisional application No. 60/516,061, filed on Oct. 29, 2003.

(51) Int. Cl. G06F 19/00; G06F 17/00

(52) U.S. Cl. 463/17

(57) ABSTRACT

The present invention relates to a lottery system and method in which the winning lottery number is known, and preferably displayed, before the lottery game commences and before any lottery tickets are sold so that players will know instanteously whether their purchased lottery ticket is a winner.

### CROSS REFERENCE TO RELATED APPLICATIONS

The present application is a continuation of pending U.S. Provisional Patent Application Ser. No. 60/516,061, which was filed on Oct. 29, 2003 and is entitled “Reverse Lottery System and Method.” The entire contents of which are expressly incorporated herein by reference.

### FIELD OF THE INVENTION

The present invention relates to a lottery system and method. More particularly, the present invention relates to a lottery system and method in which the winning lottery number is known before the lottery game commences and before any lottery tickets are sold.

### BACKGROUND OF THE INVENTION

In a normal lottery game, there is a period of time during which lottery tickets are offered for sale. These tickets are each assigned an identifier, usually a number or series of numbers, although letters, symbols, etc. (collectively “symbols”), may also be employed. After the sale period is over, a winning number is selected, and tickets matching the selected winning number are winning tickets. In some lotteries, each ticket number is unique, so that there can be only one winner per game. More commonly, duplicate numbers may be sold so that there can be more than one winner per game. The numbers may be generated randomly by a computer in response to a request for a ticket. Alternatively, a player may request to purchase a particular number, which may be duplicated (i.e., “sampling with replacement”) by another player requesting the same number, or by the computer when it randomly generates a number. With sampling with replacement, duplicate numbers may be sold thus making it possible to have duplicate winning tickets whose owners share in the winning prize. Unless all the possible numbers have been sold, it is possible that there will be no winner in the lottery. Alternatively, the lottery may continue until one of the players' numbers is matched. Where there is no winner, the prize is carried over to a subsequent lottery having a larger prize that reflects receipts from its sales and sales from the preceding lottery. There may also be different classes of prizes, including some of lower value, for players whose tickets only match part of the winning number.

Normal lottery games which incorporate sampling with replacement do not provide a player with incentive to buy additional tickets after the player's initial purchase. For example, since, to the player's knowledge, the player's first purchase of tickets might already include the winning ticket, the player has no additional incentive to purchase additional tickets, since they may not provide any additional winnings. Moreover, since a winning ticket may have already been sold, the player may, to his/her knowledge, only have a chance to share in the winning prize. Thus, players may prefer to determine whether any of his/her purchased tickets are a winner before purchasing any additional tickets. But in traditional lottery games, the player can not find out if he/she is a winner until after the winning numbers have been drawn and the lottery has ended.

Thus, there exists a need for an improved lottery system and method in which the winning number(s) or symbol(s) is known before lottery numbers and/or symbols are issued to the players.

### SUMMARY OF THE INVENTION

The present invention overcomes these and other problems by providing a lottery system in which the winning lottery number is known before the lottery game commences and before any lottery tickets are sold so that players will know instanteously whether their purchased lottery ticket is a winner.

In one embodiment, the present invention is directed to a lottery game system, comprising the steps of selecting at least one winning lottery ticket number; opening the lottery game to players so that each player may acquire a lottery ticket number; and matching the lottery ticket number with the pre-selected winning lottery ticket number to determine whether the player has purchased a winning lottery ticket.

In another embodiment, the present invention is directed to a lottery game system, comprising the steps of selecting at least one winning lottery ticket number; opening the lottery game to players so that each player may obtain at least one randomly selected generating number; inputting the at least one randomly selected generating number into an algorithm wherein the at least one randomly selected generating number may be modified by an unknown, random number so that a lottery ticket number may be generated; and matching the lottery ticket number with the pre-selected winning lottery ticket number to determine whether the player has purchased a winning lottery ticket.

In accordance with one feature of the lottery game systems disclosed above, the computer may be configured to select the randomly selected generating number at the player's request. Alternatively, the player may select the randomly selected generating number so that each player may choose a number of their choice.

In accordance with another feature of the lottery game systems disclosed above, the unknown, random number may be changed continuously during the lottery game by the substitution of a new unknown, random number. For example, the unknown, random number may be changed after each purchase of a lottery ticket. Alternatively, the unknown, random number may be changed periodically during the course of the lottery game. Alternatively, the unknown, random number may be changed after each lottery game.

In accordance with another feature of the lottery game systems disclosed above, the lottery ticket number may be unique to the combination of the unknown, random number and the randomly selected generating number so that if another players selects the same randomly selected generating number, the same lottery ticket number will be generated so long as the unknown, random number has not changed. Moreover, preferably, no two different randomly selected generating numbers in combination with the same random, unknown number will produce the same lottery ticket number.

In accordance with another feature of the lottery game systems disclosed above, each randomly selected generating number may be replaced after it is purchased so that another player may purchase the same randomly selected generating number so that the odds of picking the winning lottery ticket number remains constant throughout the entire game.

In accordance with other features of the lottery game systems disclosed above, preferably, each player knows immediately if they have selected the predetermined winning lottery ticket number. The lottery game may be closed as soon as a player selects the winning lottery ticket number. The lottery game may remain open until a player selects the winning lottery ticket number. The winning prize may be progressively increased as the game continues. The winning prize may progressively increase after a certain predetermined period of time. The lottery system may be configured so that different classes of prizes are offered. The at least one winning lottery ticket number may be displayed prior to opening the lottery game to players, and the at least one randomly selected generating number may be a number and/or symbol and the at least one winning lottery ticket number may be a number and/or symbol.

### DETAILED DESCRIPTION OF THE PREFERRED EMBODIMENT

The present invention relates to a lottery system in which the winning lottery number is known before the lottery game commences and before any lottery tickets are sold. For the purposes of promoting an understanding of the principles of the present invention, an exemplary, non-limiting embodiment will be described. It will nevertheless be understood that no limitation of the scope of the invention is hereby intended, such alterations and further modifications are contemplated as would normally occur to one skilled in the art to which the invention relates.

In the Reverse Lottery system and method of the present invention, the winning lottery number(s) and/or symbol(s) is selected before the first lottery ticket is sold. Moreover, the winning lottery number(s) and/or symbol(s) may be displayed before the first lottery ticket is sold. The issued lottery tickets may take the form, for example, of a paper ticket having the selected number(s) and/or symbol(s) printed thereon, or simply a number and/or symbol provided to the player through the Internet or other public network, or in any other form which is known in the art.

Preferably, the Reverse Lottery is a computerized lottery game so that the lottery ticket numbers are generated by a random process. For example, each issued lottery ticket may have a, or a series of, randomly selected number(s), i.e., a randomly selected lottery ticket number(s), associated therewith. In a preferred embodiment, the player has some control over the randomly selected lottery ticket number(s) assigned to the purchased lottery ticket. For example, a player may choose his/her own lottery ticket generating number(s), which may be, for example a number or series of numbers which the player considers lucky. Alternatively, a player may choose to have the computer select the lottery ticket generating number(s) for them. The lottery ticket generating number is, in a preferred embodiment, employed along with an unknown, random number into an algorithm such that the two numbers together produce the randomly selected lottery ticket number. That is, preferably, the lottery ticket generating number(s) is entered into an algorithm along with an unknown, random number so that the algorithm can transform the lottery ticket generating number(s) into the randomly selected lottery ticket number. For example, the lottery ticketing generating number may be a number or series of numbers and the unknown, random number may also be a number so that the algorithm transfers the lottery ticketing generating number(s) into a lottery ticket number which is then compared with the pre-selected winning lottery number to determine whether the player is a winner.

It should be noted that although the present invention refers to the lottery ticket generating number, unknown random number, lottery ticket number, etc. as being an actual number, it is contemplated that letters, symbols, etc. (collectively “symbols”) may also be used. For example, the lottery ticketing generating number may be a number or series of a numbers which gets transformed by the algorithm and unknown, random number into a symbol or series of symbols which is then compared with the pre-selected winning lottery symbol to determine whether the player is a winner.

The unknown, random number may be changed and/or modified continuously during the lottery game by the substitution of a new unknown, random number so that players do not receive an unfair advantage from the purchase of previously unsuccessful lottery tickets. For example, in one embodiment of the present invention, the unknown, random number may be changed after each lottery ticket purchase. Alternatively, the unknown, random number may be changed periodically during the course of the lottery game. In an alternate embodiment, the unknown, random number may be changed at the conclusion of each lottery game.

In a preferred embodiment, the random lottery ticket number produced is unique to the combination of the unknown, random number and the generating number so that, if the same randomly selected generating number is selected by another player, the results would always be that the same lottery ticket number is produced so long as the unknown, random number has not changed. In addition, for each lottery game, preferably, a particular lottery ticket number would be generated by only one unique combination of randomly selected generating number and unknown, random number. Thus, preferably, there is a one-to-one correspondence between each combination of randomly selected generating number and unknown, random number with each lottery ticket number.

Preferably, the lottery game system employs “selection with replacement” so that each selected lottery ticket generating number can be “replaced” so that the probability of any lottery ticket number being randomly selected remains constant throughout the lottery game. Selection with replacement prevents a player from obtaining an unfair advantage by waiting until some losing lottery ticket numbers have been selected, thereby increasing his/her odds of winning, since the available pool within which the winning lottery ticket number resides is reduced.

An advantage of the Reverse Lottery system is that players know immediately if they have won. Thus, a player can decide whether to purchase additional tickets immediately after he/she reviews the first purchased ticket, and so on. Moreover, in a preferred embodiment, there are no shared prizes, since the winner is known as soon as the winning lottery ticket number is selected. That is, since the existence of a winner is known immediately, no further tickets are sold for that lottery, and there is no possibility for the “selection with replacement” method to generate another winning ticket number.

In a preferred embodiment, the lottery continues until there is a winner. The winning prize may be increased progressively, as more losing tickets are sold. For example, the lottery payoff may progressive increase based upon the number of tickets purchased. Alternatively, the lottery payoff, for example, may offer a fixed sum for a period of time and then, as more losing tickets are sold beyond a predetermined number or predetermined dollar amount of tickets that were estimated would be sold when the expected payoff amount was calculated, the prize may progressively increase. Additionally, other schemes known in the art for producing a progressively increasing prize may be employed with the present invention. Also, in the present invention, other prizes in addition to the main prize may be offered.

In a preferred embodiment, the Reverse Lottery may be accessible via the Internet or other public communication network, where transactions can be completed in real time. In a preferred embodiment, the player accesses and employs a user terminal to connect through a public network, such as the Internet, to a server controlled by the operator of the Reverse Lottery. The user terminal may be, for example, a computerized device such as a desktop computer with a modem, or a mobile phone or other wireless computerized device having the capability to connect to a public network to access a connected server. In one embodiment, the player accesses a user interface, such as could be presented within a World Wide Web (WWW) site on the server. The server may generally include a computer program that provides and operates the Reverse Lottery system and method on-line, created using conventional software and programming methods. The connection between the user terminal and the server may enable communication via one or more protocols and/or programming languages supported by the user terminal. For example, the user terminal may, for example, communicate with the server by use of HTML (hypertext mark-up language). The particular type or technology of user terminal employed is not critical to the present invention. Thus, any user terminal with the ability to connect to a public network may be employed.

The Reverse Lottery provides the appeal of instant gratification, constant action, and the potential for large prizes at a small “per transaction” price to the player. It also has the attraction, from the operator's viewpoint, of encouraging impulse play.

The present invention has been described in connection with the above-illustrated example. The present invention, however, is not restricted thereto. It will be understood by those skilled in the art that other variations and modifications can easily be made within the scope of the invention as defined by the appended claims, thus it is only intended that the present invention be limited by the following claims.

1. A computerized lottery game, comprising the steps of:
(a) selecting at least one winning lottery ticket number;
(b) opening the lottery game to players so that each player may obtain at least one randomly selected generating number;
(c) inputting the at least one randomly selected generating number into an algorithm wherein the at least one randomly selected generating number is modified by an unknown, random number so that a lottery ticket number is generated; and
(d) matching the lottery ticket number with the pre-selected winning lottery ticket number to determine whether the player has purchased a winning lottery ticket.

2. The lottery game of claim 1, wherein the computer selects the randomly selected generating number at the player's request.

3. The lottery game of claim 1, wherein the player selects the randomly selected generating number so that each player may choose a number of their choice.

4. The lottery game of claim 1, wherein the lottery ticket number is unique to the combination of the unknown, random number and the randomly selected generating number so that if another player selects the same randomly selected generating number, the same lottery ticket number will be generated so long as the unknown, random number has not changed.

5. The lottery game of claim 1, wherein no two different randomly selected generating numbers in combination with the same random, unknown number will produce the same lottery ticket number.

6. The lottery game of claim 1, wherein the unknown, random number is changed continuously during the lottery game by the substitution of a new unknown, random number.

7. The lottery game of claim 1, wherein the unknown, random number is changed after each lottery ticket purchase.

8. The lottery game of claim 1, wherein the unknown, random number is changed periodically during the course of the lottery game.

9. The lottery game of claim 1, wherein the unknown, random number is changed after each lottery game.

10. The lottery game of claim 1, wherein each randomly selected generating number is replaced after it is purchased so that another player may purchase the same randomly selected generating number.

11. The lottery game of claim 1, wherein the odds of picking the winning lottery ticket number remains constant throughout the entire game.

12. The lottery game of claim 1, wherein each player knows immediately if they have selected the pre-determined winning lottery ticket number.

13. The lottery game of claim 1, wherein the lottery game is closed as soon as a player selects the winning lottery ticket number.

14. The lottery game of claim 1, wherein the lottery game remains open until a player selects the winning lottery ticket number.

15. The lottery game of claim 1, wherein the winning prize is progressively increased as the game continues.

16. The lottery game of claim 1, wherein the winning prize is progressively increased after a certain predetermined period of time.

17. The lottery game of claim 1, wherein the lottery system is configured so that different classes of prizes are offered.

18. The lottery game of claim 1, wherein the lottery game is played via the Internet.

19. The lottery game of claim 1, wherein the lottery game is played via paper tickets.

20. The lottery game of claim 1, wherein the lottery game is played over a public network.

21. The lottery game of claim 1, wherein the at least one winning lottery ticket number is displayed prior to opening the lottery game to players.

22. The lottery game of claim 1, wherein the at least one randomly selected generating number is a number and the at least one winning lottery ticket number is a number.

23. The lottery game of claim 1, wherein the at least one randomly selected generating number is a number and the at least one winning lottery ticket number is a symbol.

24. The lottery game of claim 1, wherein the at least one randomly selected generating number is a symbol and the at least one winning lottery ticket number is a number.

25. The lottery game of claim 1, wherein the at least one randomly selected generating number is a symbol and the at least one winning lottery ticket number is a symbol.

26. A lottery game, comprising the steps of:
(a) selecting at least one winning lottery ticket number;
(b) opening the lottery game to players so that each player may acquire a lottery ticket number; and
(c) matching the lottery ticket number with the pre-selected winning lottery ticket number to determine whether the player has purchased a winning lottery ticket.
